(19) United States
(12) Patent Application Publication
(10) Pub. No.: US 2009/0147760 A1
(43) Pub. Date: Jun. 11, 2009

(54) Method and apparatus for routing in wireless sensor network

(75) Inventors: Eun Ju Lee, Daejeon-city (KR); Jae Hong Ryu, Daejeon-city (KR); Bong Soo Kim, Daejeon-city (KR); Cheol Sig Pyo, Daejeon-city (KR); Jong suk Chae, Daejeon-city (KR); Hyung Seok Kim, Seoul (KR); Youn-Soo Kim, Gyeonggi-do (KR)

Correspondence Address: STAAS & HALSEY LLP, SUITE 700, 1201 NEW YORK AVENUE, N.W., WASHINGTON, DC, 20005, US

(73) Assignee: Electronics and Telecommunications Research Institute, Daejeon (KR)

(21) Appl. No.: 12/149,258

(22) Filed: Apr. 29, 2008

(30) Foreign Application Priority Data
Dec. 7, 2007 (KR) 10-2007-0126875

(51) Int. Cl. H04Q 7/24

(52) U.S. Cl. 370/338

(57) ABSTRACT

Provided are a method and apparatus for efficiently performing routing in a wireless sensor network having a tree-hierarchical structure, the method and apparatus reducing the number of hops required for transmitting data. According to the method and apparatus, a node is determined as a proximal node from among nodes within range of a wireless signal of a transmission node, wherein the node is a node having the smallest difference from among differences between each of address values of the nodes within the range and an address value of a target node, and data is directly transmitted from the transmission node to the proximal node.

### CROSS-REFERENCE TO RELATED PATENT APPLICATION

This application claims the benefit of Korean Patent Application No. 10-2007-0126875, filed on Dec. 7, 2007, in the Korean Intellectual Property Office, the disclosure of which is incorporated herein in its entirety by reference.

### BACKGROUND OF THE INVENTION

1. Field of the Invention

The present invention relates to a method and apparatus for performing routing in a network system, and more particularly, to a method and apparatus for performing routing in a sensor network configured with sensor nodes in a hierarchical structure such as a tree structure so as to reduce the number of hops required for data transmission.

The present invention is derived from a research project supported by the Information Technology (IT) Research & Development (R&D) program of the Korean Ministry of Information and Communication (MIC) and the Institute for Information Technology Advancement (IITA) [Subproject NO.: 2005-S-038-03, Subproject Name: Development of UHF RF-ID and Ubiquitous Networking Technology].

2. Description of the Related Art

A sensor network having a hierarchical structure includes a plurality of sensor nodes that are connected to each other in parent-child hierarchical trees, and each of the sensor nodes include small capacity memories and processors which can be driven by a battery. Generally, a hierarchical routing method and a table routing method are methods conventionally used for transmitting data in the sensor network.

The table routing method requires each sensor node to include a routing table related to data transmission, and thus, it is not suitable for a sensor network having a small power supply and limited memory capacity.

In contrast, the hierarchical routing method has simplified procedures for data transmission, is easily established, does not require much memory capacity for each sensor node, and thus, the method is suitable for a sensor network. However, sensor nodes belonging to a tree-hierarchical structure can transmit data only to either their parent nodes or their child nodes. In other words, if a target node is not either a parent/child node of a transmission node, it is impossible for the transmission node to transmit data directly to the target node even if the target node is adjacent to the transmission node, and thus more hops than necessary are required for data transmission. Therefore, the hierarchical routing method has problems such as a decrease in data transmission rate and an increase in traffic.

FIG. 1 is a diagram of a conventional wireless sensor network.

Referring to FIG. 1, when a transmission node 110 which is to transmit data transmits the data to a target node 170 which is to receive the data, signals of the data have to go through nodes 110, 120, 130, 140, 150, 160, and 170 in sequence along a tree structure even if the target node 170 is within range of a wireless signal of the transmission node 110, and thus six hops are required for the data transmission.

FIG. 2 is another diagram of a conventional wireless sensor network.

Referring to FIG. 2, when a transmission node 210 transmits data to a target node 260, two hops are required if the data is transmitted through a node 270 which is within range of a wireless signal of the transmission node 210. However, five hops are required if the data is transmitted along a tree structure, or through nodes 210, 220, 230, 240, 250, and 260.

### SUMMARY OF THE INVENTION

The present invention provides a method of reducing the number of hops required for data transmission and unnecessary traffic in a sensor network by determining a next sensor node to which data is to be transmitted, based on a proximity of the sensor node to a target node prior to the transmission of data, and thus throughput of each node is improved.

According to an aspect of the present invention, there is provided a method of performing routing in a wireless sensor network having a tree-hierarchical structure, the method including determining a node from among nodes within range of a wireless signal of a transmission node as a proximal node, wherein the node is a node having the smallest difference from among differences between each of address values of the nodes within the range and an address value of a target node, and directly transmitting data from the transmission node to the proximal node, which is a node connected to the target node in the tree-hierarchical structure.

According to another aspect of the present invention, there is provided an apparatus for performing routing in a wireless sensor network having a tree-hierarchical structure, the apparatus including a proximal node determining unit determining a node from among nodes within range of a wireless signal of a transmission node as a proximal node, wherein the node is a node having the smallest difference from among differences between each of address values of the nodes within the range and an address value of a target node, and a transmission unit directly transmitting data from the transmission node to the proximal node, which is a node connected to the target node in the tree-hierarchical structure.

According to the method of routing in a wireless sensor network, the number of hops required for transmitting data can be reduced, and thus unnecessary traffic in the sensor network can be reduced and throughput of each node can be improved.

An example of network systems to which the method of data routing according to the present invention can be applied is a ZigBee network system-based on IEEE802.15.4 standard, but the method can also be applied to an IP network system based on a IPv6 address system.

### BRIEF DESCRIPTION OF THE DRAWINGS

The above and other features and advantages of the present invention will become more apparent by describing in detail exemplary embodiments thereof with reference to the attached drawings in which:

FIG. 1 is a diagram of a conventional wireless sensor network;

FIG. 2 is another diagram of a conventional wireless sensor network;

FIG. 3 is a diagram for explaining a concept of a wireless sensor network according to an embodiment of the present invention;

FIG. 4 is a flowchart of a method of routing in a wireless sensor network according to an embodiment of the present invention;

FIG. 5 is a detailed flowchart of operation S470 in FIG. 4 according to an embodiment of the present invention;

FIG. 6 is a block diagram of an apparatus for performing routing in a wireless sensor network according to an embodiment of the present invention; and

FIG. 7 is a block diagram of an apparatus for performing routing in a wireless sensor network according to another embodiment of the present invention.

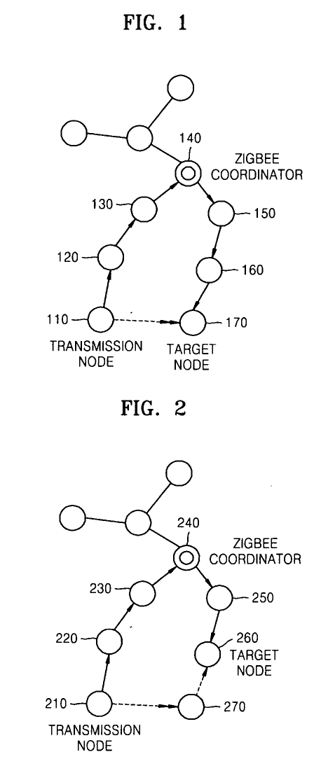

### DETAILED DESCRIPTION OF THE INVENTION

The present invention will now be described more fully with reference to the accompanying drawings, in which exemplary embodiments of the invention are shown.

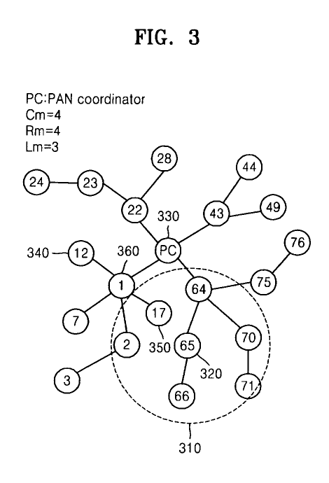

FIG. 3 is a diagram for explaining a concept of a wireless sensor network according to an embodiment of the present invention.

Referring to FIG. 3, PC 330 represents a personal area network (PAN) coordinator (PC) 330, and numbers on nodes respectively represent addresses of the nodes. If a transmission node is a node having an address of 65, which is denoted as 320, a region 310 is the coverage of the transmission node 320, which wireless signals of the transmission node 320 can reach. If a neighboring node which is a node within the coverage is either a target node or a node close to the target node, data is transmitted directly from the transmission node 320 to the neighboring node rather than being transmitted along a tree structure.

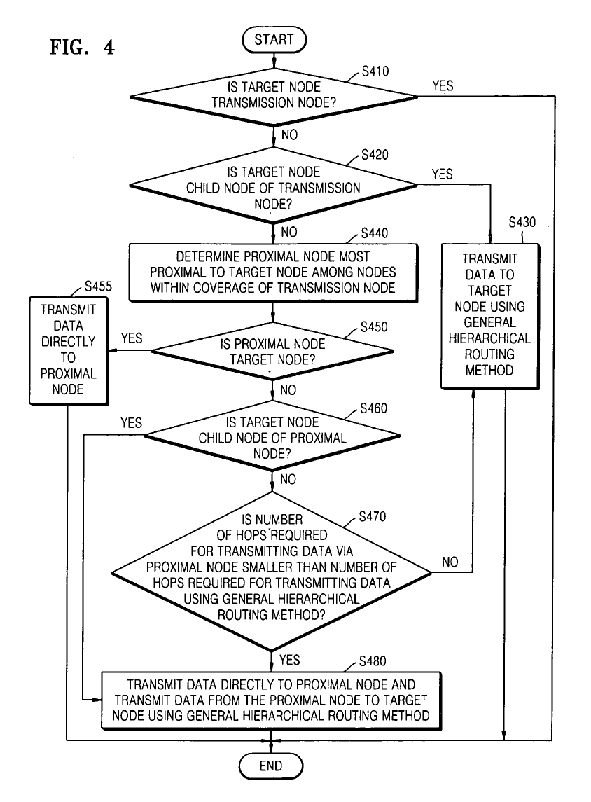

FIG. 4 is a flowchart of a method of routing in a wireless sensor network according to an embodiment of the present invention.

Referring to FIG. 4, when a transmission node receives data, the transmission node determines whether a target node of the data is the transmission node itself (operation S410). If the transmission node is the target node of the data, the transmission node terminates data transmitting. If the transmission node is not the target node of the data, the transmission node determines whether the target node of the data is a child node of the transmission node. If the target node is a child node of the transmission node, the data is transmitted along a tree structure, as by the conventional method, to the target node or a parent node of the target node (operation S430).

If the target node is neither the transmission node nor a child node of the transmission node in the tree structure, the transmission node determines a node to which the data is transmitted by searching a node closest to the target node within the coverage of the transmission node (operation 440), wherein the node closest to the target node will be referred as a proximal node hereinafter. The proximal node can be determined by using various methods. According to an embodiment of the present invention, differences between an address value of the target node D and each of address values of neighboring nodes within the coverage of the transmission node Aₖ are calculated in turn and a neighboring node having an address value which makes an calculated value corresponding to the address value Aₖ itself the smallest of the calculated values is determined as the proximal node. The determination of the proximal node is expressed as Equation 1.

$${min}_{k} \vert D - {A}_{k} \vert \qquad [ Equation 1 ]$$

If a value calculated using Equation 1 is zero, the result is the smallest possible absolute value, and thus a neighboring node corresponding to the calculated value becomes the proximal node (operation 450). Also, since the address value of the target node D is equal to the address value Aₖ of the proximal node, the proximal node becomes the final target node of the data. Therefore, the transmission node transmits the data to the proximal node (operation 455), and the data transmitting operation is terminated.

If the proximal node is not the target node, the transmission node determines whether the target node is a child node of the proximal node (operation S460). At this point, if the address value of the target node D is greater than the address value of the proximal node A_{c} and is smaller than the sum of the address value of the proximal node A_{c} and an interval for address values of nodes having a same depth as the proximal node, the target node may be determined as a child node of the proximal node.

In other words, if Equation 2 is satisfied, the transmission node determines that the target node is a child node of the proximal node, and transmits the received data to the proximal node (operation 480). In Equation 2, Cm represents a maximum possible number of child nodes per parent node, Rm represents a maximum possible number of child nodes, which are routers, per parent node, Lm represents a maximum possible depth of a network, and Cskip(d−1) represents an interval for address values of nodes which depths are d. In FIG. 3, the value of Cskip(0) is 21, while the value of Cskip(1) is 5.

$${A}_{c} < D < {A}_{c} + Cskip ( D ( {A}_{c} ) - 1 ) \\ Cskip ( d ) = \{ \frac{\begin{matrix}1 + Cm \cdot ( Lm - d - 1 ) , & if Rm = 1 \\ 1 + Cm - Rm - Cm \cdot {Rm}^{Lm - d - 1} & \end{matrix}}{1 + Rm} , otherwise . \qquad [ Equation 2 ]$$

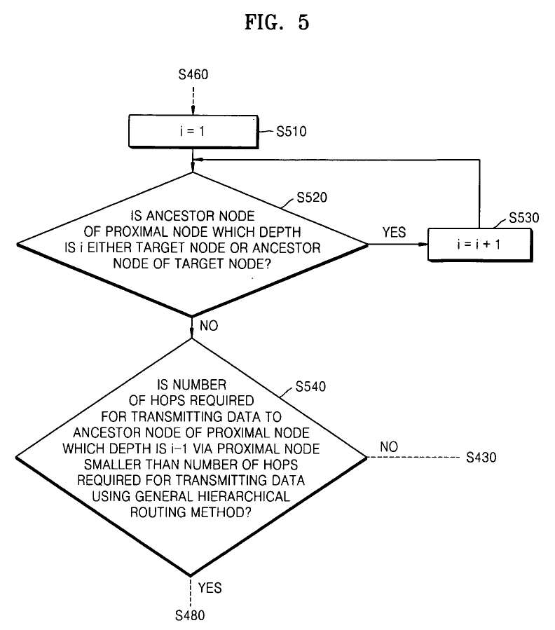

If the proximal node is not the target node and the target node is not a child node of the proximal node, the number of hops required for transmitting data from the transmission node to the proximal node directly and transmitting the data from the proximal node to the target node using a general hierarchical routing method and the number of hops required for transmitting the data from the transmission node to the target node using the general hierarchical routing method without considering the proximal node are compared (operation S470). Operation S470 will be described in detail with reference to FIG. 5 below.

FIG. 5 is a detailed flowchart of operation S470 in FIG. 4 according to an embodiment of the present invention.

Referring to FIG. 5, beginning with an ancestor node of the proximal node which depth is 1 (operation S510), it is determined whether the ancestor node is the target node or the ancestor node is an ancestor node of the target node (operation S520). A method of determination is described below.

First, it is necessary to calculate address values of ancestor nodes of the proximal node on the network. According to an embodiment of the present invention, not only an address value of a parent node of the proximal node but also address values of parent nodes of the parent node, that is, the address values of ancestor nodes at each depth in a network system having a tree-hierarchical structure, are calculated recursively according to Equation 3. In Equation 3, anc(A_{c}, i) is a function representing an address value of an ancestor node of the proximal node, which depth is i, wherein the anc(A_{c}, i) is a recursive function satisfying anc(A_{c},0)=0, floor(x) indicates the largest integer below x, and Cskip(d) is the same as in Equation 2.

$$anc ( {A}_{c} , i ) = anc ( {A}_{c} , i - 1 ) + 1 + floor ( \frac{{A}_{c} - anc ( {A}_{c} , i - 1 ) - 1}{Cskip ( i - 1 )} ) * Cskip ( i - 1 ) \qquad [ Equation 3 ]$$

Once the address value of the ancestor node (anc(A_{c}, i)) is calculated, it is determined whether the address value of the target node D is greater than the address value of the ancestor node (anc(A_{c}, i)) and is smaller than the sum of the address value of the ancestor node(anc(A_{c}, i)) and an interval for address values of nodes which depths in the network are i. In other words, it is determined whether Equation 4 is satisfied.

anc(A_{c},i)≦D<anc(A_{c},i)+Cskip(i−1) [Equation 4]

If the equation shown in Equation 4 is satisfied, operation 520 is repeated after i is increased by 1 (operation 530).

The operation 520 and the operation 530 are repeated until Equation 4 is no longer satisfied, that is, with respect to the ancestor node of the proximal node, which depth is i, until the target node is neither the ancestor node nor a child node of the ancestor node.

If the address value of the target node and the address value of the ancestor node of the proximal node which has been calculated does not satisfy Equation 4, that is, if the target node is neither the ancestor node which address value has been calculated nor a child node of the ancestor node, the transmission node compares the number of hops H_{zc} required for transmitting data using a general hierarchical routing method and the number of hops H_{NB} required for transmitting data by directly transmitting the data to the proximal node and thereafter transmitting the data from the proximal node to the target node using the general hierarchical routing method (operation S540), and transmits the data via a route with a smaller number of hops (operation S480 and operation S430).

At this point, an equal number of hops is required to transmit data from an ancestor node which is at the maximum depth, among ancestor nodes of the proximal node, satisfying Equation 4, wherein the ancestor node will be referred as a shared node hereinafter, to the target node in either of the transmission methods. Therefore, the number of hops from the transmission node to a shared node should be compared.

Referring to FIG. 3, a node 320 having an address value 65 is a transmission node and a node 340 having an address value 12 is a target node, for example. A node within the coverage of the transmission node 320 and having the address value which is closest to that of the target node 340 is a node 350 having an address 17. Therefore, the node 350 having the address 17 is a proximal node 350. An address value of an ancestor node of the proximal node, wherein the ancestor node is in depth of 1, is 1 according to Equation 3, and the calculated value is equal to an address value of an ancestor node of the proximal node 360 which depth is 1 in FIG. 3. Since the ancestor node 360 is a node satisfying Equation 4 and the proximal node 350 has a depth which is equal to a sum of a depth of the ancestor node 360 and 1, a node which has the maximum depth from among ancestor nodes of the proximal node which satisfy Equation 4 is the ancestor node 360 which has the address value of 1.

After the node which has the maximum depth is determined, H_{zc} and H_{NB} are compared. The number of hops required for transmitting data from the transmission node 320 to the ancestor node 360 using a general hierarchical routing method is equal to sum of the number of hops from the transmission node 320 to the PC 330, which is the depth d of the transmission node 320, and the number of hops from the PC 330 to the ancestor node 360, which is the depth of the ancestor node 360 shown as (i−1) in FIG. 5. Therefore, H_{zc} is equal to d+i−1=3+1=4.

In contrast, when the number of hops required for directly transmitting data from the transmission node 320 to the proximal node 350 and transmitting the data from the proximal node 350 to the ancestor node 360 thereafter is calculated, the number of hops required for directly transmitting the data from the transmission node 320 to the proximal node 350 is 1. Meanwhile, the number of hops required for transmitting the data from the proximal node 350 to the ancestor node 360 is equal to a value calculated by subtracting the depth of the ancestor node 360 (i−1) from the depth of the proximal node 350 (d(A_{c})), which is 1 in FIG. 3, and thus H_{NB} is equal to d(A_{c})−(i−1)+1=2−0+1=3.

Therefore, since H_{NB} is smaller than H_{zc}, the data is directly transmitted to the proximal node first, and then transmitted to the target node.

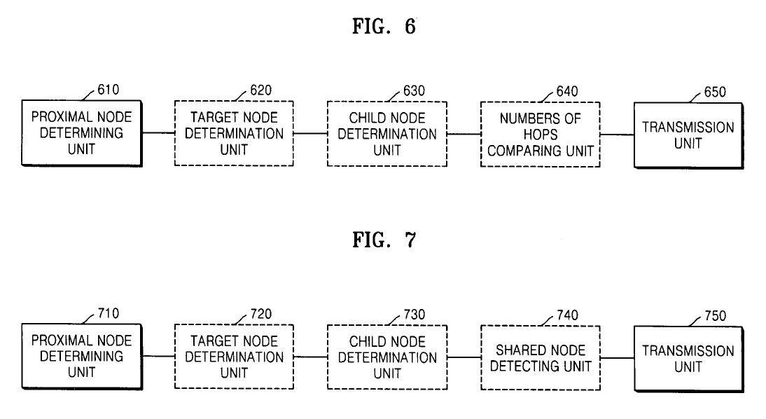

FIG. 6 is a block diagram of an apparatus for performing routing in a wireless sensor network according to an embodiment of the present invention.

Referring to FIG. 6, a proximal node determining unit 610 determines a neighboring node closest to a target node within the range of a wireless signal of a transmission node, that is, within the coverage of the transmission node as a proximal node. At this point, a neighboring node, having a smallest value from among values of differences between the address value of the target node and the address values of each neighboring node, is determined as the proximal node.

The proximal node determining unit 610 does not determine a proximal node if the transmission node is either the target node or a parent or child node of the target node. Data transmission is terminated if the transmission node is the target node. On the other hand, if the transmission node is either a parent node or child node of the target node, the data is transmitted from the transmission node to the target node.

The transmission unit 650 directly wirelessly transmits data from a transmission node to a proximal node. The data which has reached the proximal node is transmitted to a target node along a tree structure.

The transmission unit 650 may transmit the data using a method requiring a smaller number of hops for data transmission, wherein a numbers of hops comparing unit 640 is used by comparing H_{zc} and H_{NB}.

Also, the apparatus for performing routing in a wireless sensor network may further include a target node determination unit 620 determining whether a proximal node is the target node when the proximal node determining unit 610 determines the proximal node. The transmission unit 650 may directly transmit data from the transmission node to the proximal node if the proximal node is determined as the target node by the target node determination unit 620. On the other hand, if the proximal node is not determined as the target node by the target node determination unit 620, the transmission node transmits the data by using a method which requires the least number of hops for data transmission.

Also, the apparatus for performing routing in a wireless sensor network may further include a child node determination unit 630 determining whether the target node is a child node of the proximal node. The transmission unit 650 may directly transmit data from the transmission node to the proximal node if the target node is determined as a child node of the proximal node by the child node determination unit 630. On the other hand, if the target node is not determined as the child node of the proximal node by the child node determination unit 630, the transmission unit 650 may transmit the data using whichever one of the methods requires the least number of hops for data transmission.

FIG. 7 is a block diagram of an apparatus for performing routing in a wireless sensor network according to another embodiment of the present invention.

Referring to FIG. 7, a proximal node determining unit 710, a target node determination unit 720, and a child node determination unit 730 are the same as the proximal node determining unit 610, the target node determination unit 620, and the child node determination unit 630, shown in FIG. 6, respectively. However, a shared node detecting unit 740 is presented instead of a numbers of hops comparing unit 640.

Both the method of transmitting data from a transmission node to a target node using a general hierarchical routing method and the method of transmitting data from the transmission node to a proximal node and transmitting data from the proximal node to the target node using the general hierarchical routing method require the same number of hops from the target node or an ancestor node which is at the maximum depth among ancestor nodes of the target node, among ancestor nodes of the proximal node (which is a shared node) to the target node. Therefore, the shared node detecting unit 740 detects the shared node. A method of detecting the shared node is the same as in the descriptions relating to FIGS. 4 and 5.

A transmission unit 750 transmits data from a transmission node to a shared node using whichever one of the two methods described above that requires the smaller number of hops for data transmission. In other words, if the sum of the number of the hops between a proximal node and the shared node and 1 is smaller than the number of hops from the transmission node to the shared node, data is directly transmitted from the transmission node to the proximal node, and then the data is transmitted from the proximal node to the target node using a general hierarchical routing method.

While the present invention has been particularly shown and described with reference to exemplary embodiments thereof, the spirit and scope of the present invention should not be construed as being limited to the embodiments set forth herein and may be embodied in many different forms; rather, these embodiments are provided so that this disclosure will be thorough and complete, and will fully convey the concept of the invention to those of ordinary skill in the art.

What is claimed is:

1. A method of performing routing in a wireless sensor network having a tree-hierarchical structure, the method comprising:
determining a node from among nodes within range of a wireless signal of a transmission node as a proximal node, wherein the node is a node having the smallest difference from among differences between each of address values of the nodes within the range and an address value of a target node; and
directly transmitting data from the transmission node to the proximal node, which is a node connected to the target node in the tree-hierarchical structure.

2. The method of claim 1, further comprising:
comparing the number of hops required for transmitting the data from the transmission node to the target node using a hierarchical routing method with the number of hops required for transmitting the data from the transmission node to the proximal node directly and transmitting the data from the proximal node to the target node using the hierarchical routing method,
wherein the data is directly transmitted from the transmission node to the proximal node if the number of hops required for transmitting the data from the transmission node to the proximal node directly and transmitting the data from the proximal node to the target node using the hierarchical routing method is smaller than the number of hops required for transmitting the data from the transmission node to the target node using the hierarchical routing method.

3. The method of claim 1, further comprising determining whether the target node is the proximal node,
wherein the data is directly transmitted from the transmission node to the proximal node if the target node is the proximal node, or if the number of hops required for transmitting the data from the transmission node to the proximal node directly and transmitting the data from the proximal node to the target node using a hierarchical routing method is smaller than the number of hops required for transmitting the data from the transmission node to the target node using the hierarchical routing method.

4. The method of claim 1, further comprising determining whether the target node is a child node of the proximal node,
wherein the data is directly transmitted from the transmission node to the proximal node if the target node is a child node of the proximal node or if the number of hops required for transmitting the data from the transmission node to the proximal node directly and transmitting the data from the proximal node to the target node using a hierarchical routing method is smaller than the number of hops required for transmitting the data from the transmission node to the target node using the hierarchical routing method.

5. The method of claim 4, wherein it is determined that the target node is a child node of the proximal node if the address value of the target node is greater than an address value of the proximal node and is smaller than a sum of the address value of the proximal node and an interval for address values of nodes having a same depth as the proximal node.

6. The method of claim 1, further comprising detecting an ancestor node, which is either the target node or a node which has a maximum depth from among ancestor nodes of the target node, from among ancestor nodes of the proximal node,
wherein the data is directly transmitted from the transmission node to the proximal node if a sum of the number of hops from the proximal node to the node which has the maximum depth and 1 is smaller than the number of hops from the transmission node to the node which has the maximum depth.

7. The method of claim 6, wherein the detecting of the ancestor node comprises detecting the node which has the maximum depth from among ancestor nodes of the proximal node which have address values, each of which is smaller than the address value of the target node and a sum of each of which and an interval for address values of nodes having a same depth as the each is greater than the address value of the target node.

8. The method of claim 1, wherein the proximal node is determined in the determining of the node, if the target node is neither the transmission node nor a parent or child node of the transmission node.

9. An apparatus for performing routing in a wireless sensor network having a tree-hierarchical structure, the apparatus comprising:
a proximal node determining unit determining a node from among nodes within range of a wireless signal of a transmission node as a proximal node, wherein the node is a node having the smallest difference from among differences between each of address values of the nodes within the range and an address value of a target node; and
a transmission unit directly transmitting data from the transmission node to the proximal node, which is a node connected to the target node in the tree-hierarchical structure.

10. The apparatus of claim 9, further comprising a numbers of hops comparing unit comparing the number of hops required for transmitting the data from the transmission node to the target node using a hierarchical routing method with the number of hops required for transmitting the data from the transmission node to the proximal node directly and transmitting the data from the proximal node to the target node using the hierarchical routing method,
wherein the transmission unit directly transmits the data from the transmission node to the proximal node if the number of hops required for transmitting the data from the transmission node to the proximal node directly and transmitting the data from the proximal node to the target node using the hierarchical routing method is smaller than the number of hops required for transmitting the data from the transmission node to the target node using the hierarchical routing method.

11. The apparatus of claim 9, further comprising a target node determination unit determining whether the target node is the proximal node,
wherein the transmission unit directly transmits the data from the transmission node to the proximal node if the target node is the proximal node, or if the number of hops required for transmitting the data from the transmission node to the proximal node directly and transmitting the data from the proximal node to the target node using a hierarchical routing method is smaller than the number of hops required for transmitting the data from the transmission node to the target node using the hierarchical routing method.

12. The apparatus of claim 9, further comprising a child node determination unit determining whether the target node is a child node of the proximal node,
wherein the transmission unit directly transmits the data from the transmission node to the proximal node if the target node is a child node of the proximal node or if the number of hops required for transmitting the data from the transmission node to the proximal node directly and transmitting the data from the proximal node to the target node using a hierarchical routing method is smaller than the number of hops required for transmitting the data from the transmission node to the target node using the hierarchical routing method.

13. The apparatus of claim 12, wherein the child node determination unit determines that the target node is a child node of the proximal node if the address value of the target node is greater than an address value of the proximal node and is smaller than a sum of the address value of the proximal node and an interval for address values of nodes having a same depth as the proximal node.

14. The apparatus of claim 9, further comprising a shared node detecting unit detecting a shared node, which is either the target node or a node which has a maximum depth from among ancestor nodes of the target node, from among ancestor nodes of the proximal node,
wherein the transmission unit directly transmits the data from the transmission node to the proximal node if a sum of the number of hops from the proximal node to the node which has the maximum depth and 1 is smaller than the number of hops from the transmission node to the node which has the maximum depth.

15. The apparatus of claim 14, wherein the shared node detecting unit detects the node which has the maximum depth from among ancestor nodes of the proximal node which have address values, each of which is smaller than the address value of the target node and a sum of each of which and an interval for address values of nodes having a same depth as the each is greater than the address value of the target node.

16. The apparatus of claim 9, wherein the proximal node determining unit determines the proximal node, if the target node is neither the transmission node nor a parent or child node of the transmission node.
